(19) United States
(12) Patent Application Publication
(10) Pub. No.: US 2018/0082291 A1
(43) Pub. Date: Mar. 22, 2018

(54) Systems and Methods that Utilize Blockchain Digital Certificates for Data Transactions

(71) Applicant: Kountable, Inc., San Francisco, CA (US)

(72) Inventors: Craig M. Allen, Keller, TX (US); Christopher Hale, Mill Valley, CA (US); Catherine Nomura, Mill Valley, CA (US)

(21) Appl. No.: 15/787,674

(22) Filed: Oct. 18, 2017

Related U.S. Application Data
(63) Continuation of application No. 15/268,504, filed on Sep. 16, 2016.

(51) Int. Cl. G06Q 20/38; G06Q 20/10; H04L 29/06; H04L 9/32

(52) U.S. Cl. CPC G06Q 20/38215; G06Q 2220/00; G06Q 20/10; H04L 9/3263; H04L 63/083

(57) ABSTRACT

Systems and methods that use blockchain digital certificates are described herein. One embodiment includes generating a digital certificate including transaction data for a transaction, creating a blockchain blob of the transaction data, generating an electronic ownership token for the digital certificate, and transferring the electronic ownership token to an owner of the digital certificate.

### CROSS REFERENCE TO RELATED APPLICATIONS

This Non-Provisional Patent Application is a continuation of, and claims the benefit of, U.S. patent application Ser. No. 15/268,504, filed Sep. 16, 2016, entitled “Systems and Methods that Utilize Blockchain Digital Certificates for Data Transactions”. This Non-Provisional Patent Application is related to U.S. application Ser. No. 14/671,868, filed on Mar. 27, 2015, entitled “Multi-Variable Assessment Systems and Methods that Evaluate and Predict Entrepreneurial Behavior”. All of the aforementioned disclosures are hereby incorporated by reference herein in their entireties including all references cited therein.

### FIELD OF THE INVENTION

The present technology is directed to blockchain technology, and more specifically, but not by limitation, to systems and methods that utilize blockchain technology and tokenization to any of control ownership, distribution, and visualization of data.

### SUMMARY

According to some embodiments, the present technology is directed to a method comprising: (a) generating a digital certificate including transaction data for a transaction; (b) creating a blockchain blob of the transaction data; generating an electronic ownership token for the digital certificate; and (c) transferring the electronic ownership token to an owner of the digital certificate.

In some embodiments, the present disclosure is directed to a system of one or more computers which can be configured to perform particular operations or actions by virtue of having software, firmware, hardware, or a combination of them installed on the system that in operation causes or cause the system to perform the actions and/or method steps described herein. One or more computer programs can be configured to perform particular operations or actions by virtue of including instructions that, when executed by data processing apparatus, cause the apparatus to perform the actions. One general aspect includes actions such as generating a digital certificate including transaction data for a transaction; creating a blockchain blob of the transaction data, generating an electronic ownership token for the digital certificate, and transferring the electronic ownership token to an owner of the digital certificate. Other embodiments of this aspect include corresponding computer systems, apparatus, and computer programs recorded on one or more computer storage devices, each configured to perform the actions of the methods.

In another embodiment, the present disclosure comprises a method, including: (a) generating a digital certificate for a transaction, the digital certificate comprising a blockchain blob transaction information; (b) tracking transaction data for the transaction during a transaction timeframe; (c) periodically updating a blockchain blob of the digital certificate with the transaction data during the transaction timeframe; and (d) providing access to the blockchain blob using one or more access tokens that each include visibility rights. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of a process for creating, maintaining, and utilizing a blockchain digital certificate of the present disclosure.

FIG. 2 is a flowchart of an example method of the present disclosure.

FIG. 3 is another flowchart of an example method of the present disclosure.

FIG. 4 is an additional flowchart of another example method of the present disclosure.

FIG. 5 illustrates an example block chain blob creation process as well as a rights wallet.

FIGS. 6 and 7 collectively illustrate the process of creating a block chain blob that is stored in a data store and decrypted for a party when a view token is presented.

FIG. 8 illustrates another example use case for implementing aspects of the present disclosure in a trade transaction.

FIG. 9 is an example computing device that can be used to practice aspects of the present technology.

### DETAILED DESCRIPTION

The present disclosure is directed generally to using digital transaction systems and methods. In some embodiments, the digital transactions systems and methods employ blockchain technology to create digital certificates that are representative of a transaction. The digital certificate can comprise a blockchain blob that is continually updated as a transaction develops. For example, transaction data is added to the blockchain blob as it is created during the transaction such as documents relating to the transaction, communications between parties, and other information such as behavioral data of parties, scores calculated for the parties using the behavioral data, and location—based data for the parties—just to name a few. Additional details regarding the creation and composition of a blockchain blob of a digital certificate are described in greater detail herein.

In some embodiments, the use of a digital certificate allows for bifurcation of ownership rights from inspection/visibility rights such that the owner of the digital certificate can issue tokens to other parties that provide specifically tailored visibility rights that allow the parties to examine relevant portions of transaction information for a transaction.

These and other advantages of the present disclosure are described in greater detail below with reference to the collective drawings.

For context, an example digital certificate, such as a certificate of trade comprises a summation or package of rights and benefits of parties to a transaction, as well as detailed transaction information associated with a transaction. By way of example, the transaction information can include a right to receive a final payment from an end purchaser. The digital certificate can also comprise a specified payment amount, a currency, a country and a bank at which settlement occurs. The digital certificate exists in electronic or paper form and all (or at least a portion) information associated with a transaction represented by a digital certificate is available through an electronic data portal.

Digital certificates of the present disclosure are provided to facilitate various aspects of many types of global trade transactions. Often, the seller of goods or equipment will not ship to certain locations without receiving a payment, in advance. At the same time, the purchaser of those goods or equipment will not pay for them without having them in hand or installed. This delay between the time at which someone must pay the seller for goods and the time at which the buyer agrees to pay means that a gap filling procedure is needed. Thus, the digital certificate provides an advantageous means of providing transaction support and verification of transaction data.

Digital certificates create a ‘packaging’ of all required agreements (e.g., documents, communications, forms, and so forth) and information associated with a transaction. The digital certificate converts the somewhat amorphous rights and responsibilities associated with a trade transaction into something concrete and enforceable. Digital certificate are transferable, meaning that an owner of a digital certificate can easily sell the entire packaged version of the trade, including the right to receive the settlement payment, to another party.

A digital certificate is initiated as a bundling of information about a potential transaction. This includes a digital fingerprint of an aspiring entrepreneur that proposes the trade transaction. In some embodiments, the entrepreneur is in the developing world, where capital is most scarce. If that digital fingerprint suggests that the entrepreneur is both worthy and capable of completing the transaction, then the proposed digital certificate moves to the next state in its creation. Systems and methods for analyzing a digital fingerprint of an entrepreneur are found in co-pending application (U.S. application Ser. No. 14/671,868, filed on Mar. 27, 2015, entitled “Multi-Variable Assessment Systems and Methods that Evaluate and Predict Entrepreneurial Behavior”).

In some embodiments, a transaction worthiness of an entrepreneur is measured based on a standard banking and commercial set of criteria and information—which comprises background data and various types of assurance that the entrepreneur is not associated with money-laundering, crime or fraud networks—and evidence that the people involved in the transaction are legitimate. This information is known as the KYC (for Know Your Customer) file and is created prior to any party connecting to an international banking system. The capability of the entrepreneur is measured based on behavioral indicators collected by the systems and methods described herein and on publicly available information from third parties such as governmental databases, court records, newspapers, legal filings, and so forth.

Some embodiments of the present disclosure utilize information obtained from proprietary/private data sources (in addition to, or in lieu of publically available information). Examples of proprietary/private data sources include, but are not limited to government-issued ID numbers or other similar information that is not generally public information (or which we consider “PII” or “personally identifying information). Private banking, legal, or other records can be obtained from various databases.

This amalgamation of third party data (both from public and private sources) can be used to create a score “kScore” which is indicative of an entrepreneur's ability to successfully execute transactions. Again, some data utilized in the analysis of the transaction can be provided directly by the entrepreneur. Information relating to the KYC file and to supporting the kScore of the entrepreneur are attached to the digital certificate.

If the entrepreneur passes the KYC and kScore filtering processes, then the proposed digital certificate is allowed to progress to the next stage of development which involves the inclusion of transaction specific information. Transaction information that is included in the proposed digital certificate is related to the goods associated with the trade, the purchaser and their strength, the supplier of the goods, the means of shipment, the final payment amount and currency, the timing of the various ‘legs’ of the transaction process, the expected final payment date, and so forth—together with the KYC file, kScore and other information required to evaluate the supplier and the purchaser of goods. Once all of this information is accumulated and packaged into the developing digital certificate record, then the proposed digital certificate is filtered based upon the demand for characteristics of the proposed trade.

If this digital certificate, which is nearly ready for issuance, passes all of these filtering processes, then in some embodiments the digital certificate is optionally passed to a funding committee where real-live trade investment professionals discuss and debate the merits of the proposed transaction. The identity of these professionals, the time and date of the meeting and important notes from their discussion are attached to the digital certificate and a determination is made by this committee as to whether the project should proceed to funding.

A digital certificate that has been approved by the funding committee is ready to be ‘issued’ as a live transaction. First, the entrepreneur is notified that a digital certificate transaction is pending and final stipulations associated with the trade to be satisfied. These final stipulations can include specifying a bank account into which the final payment by the purchaser is made (which account can be under the control of the digital transaction certificate system).

Final contractual agreements are digitally signed and exchanged between the entrepreneur and the digital transaction certificate system. These digital documents are attached to the nearly complete digital certificate. The banking details associated with payments to the suppliers, including the time, means and amounts paid, are included. Agreement of the buyer of goods and acknowledgment of the payment account can also be obtained.

Once all of this information is packaged into the digital certificate, it is ready to be issued and funded. The digital transaction certificate system closes and initially funds a digital certificate and from the digital certificate warehouse a closed and funded digital certificate can be transferred to a first owner.

Over the life of the digital certificate, additional information is added to the digital certificate. When any new document or communication is received by a transaction monitor of the digital transaction certificate system, then that new piece of information is attached to the digital certificate.

Strict communication requirements are associated with the digital certificate transactions in some embodiments. The entrepreneurs involved convey to the transaction monitor via a secure communication portal documents relating to the transaction. Examples of documents include when a shipping invoice from the supplier, a Bill of Lading, a Customs Invoice, as well as other similar documents that would be known to one of ordinary skill in the art. All of this information constitutes a dynamic and growing record of how the trade transaction is unfolding. The digital certificate comprises a concatenation or summation of this transaction information.

At any stage of the transaction process, the digital certificate contains up-to-the-minute information about the transaction including what was known at evaluation process and what is the current state of the transaction, communications with the entrepreneur and any new adjustments to schedules, and so forth.

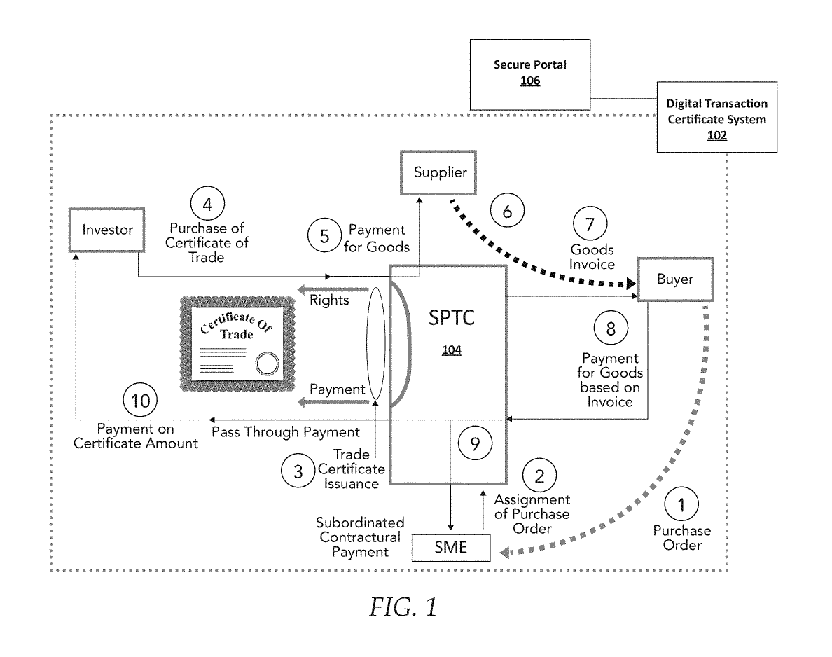

The following description provides a use case example of a process for creating, maintaining, and utilizing a digital certificate of the present disclosure. FIG. 1 illustrates these example processes. In step 1, a small/medium enterprise (“SME”) receives a purchase order from a Buyer. The purchase order represents an obligation on the part of the Buyer to accept and pay for certain specified goods when delivered in accordance with the requirements enumerated in the agreement. In some locations this is called a ‘tender’ or a ‘purchase contract.’

The SME communicates with a digital transaction certificate system 102 to determine if the transaction qualifies for the SPTC/digital certificate program. The SME authorizes the digital transaction certificate system 102 to perform a thorough due diligence investigation on the parties to the transaction. If the SME is informed by the digital transaction certificate system 102 that the proposed transaction is accepted, then, the process of creating the digital certificate on this specific transaction continues.

If the SME does not accept the terms offered, then the digital certificate creation process stops.

In step 2, the SME assigns the qualifying purchase order to the Special Purpose Trading Company (“SPTC”) 104 that is established by the digital transaction certificate system 102 in any local country. In some embodiments, the county can include a tax-favorable jurisdiction such as Jersey, Channel Islands, and so forth. This assignment conveys to the SPTC 104 the rights and benefits of the purchase order, including the right to deliver the goods that were ordered by the Buyer, as well as the right to invoice and collect payment directly from the Buyer of the goods. This assignment is acknowledged by the Buyer who agrees, that once the goods specified in the purchase order are accepted, to make payments into the bank account specified within the assignment agreement. These final payments are made to an account controlled by the digital transaction certificate system 102.

In step 3, a digital certificate is finalized with respect to the assigned purchase order transaction and issued by the SPTC 104. This digital certificate is a wrapping together of all rights, benefits, and value associated with the trade transaction. It includes the senior payment collection right against the payment expected to be made from the Buyer once the goods are delivered; it includes recovery rights against the goods ordered to fulfill the purchase order; and it includes the benefits of the contractual relationship with the SME owner that brought the transaction as enforced and implemented by the SPTC 104. The digital certificate also provides for visibility into the transaction itself.

The digital transaction certificate system 102 provides a secure portal 106 that is accessible through a public API. Using the secure portal 106, a publicly published, encrypted, blockchain blob of all transaction data is accessible to an authorized party.

In some embodiments the blockchain blob comprises a blob of data that is created by an asset servicer or management system (such as the SPTC 104). After a trade-related asset is originated, there is continuing (or periodic) contact with transaction counterparts and updates are made to the blob of data that is currently in circulation. Data continue to flow to the asset servicer with respect to the supplier initiating the shipment of goods, the transit documentation as logistics provider move goods, of project milestone tracking and communication records are updated reflecting conversations and documentation received as the goods make their way to the final purchaser.

The SPTC 104 maintains these documents and the communications channels with all transaction counterparts. For example, when the goods associated with a trade transaction have been delivered to a purchaser, and the purchaser acknowledges as valid the receivable payable with respect to that trade transaction, notification of this event, together with supporting data or documentary evidence, would cause an update to the information blob associated with that trade asset. Each succeeding information update would be added to the blob of data in circulation with respect to that asset.

In some embodiments, an owner of the digital certificate is enabled to see up-to-the-minute information about the trade transaction such as where the goods are, what delivery stage has been achieved, the communications with a supplier, a buyer and the SME, as well as a clear accounting of the trade finances, including an anticipated transaction completion date and an estimate of the underlying collateral value (based upon the materials owned by the SPTC 104 and the completion progress of the trade). At each moment of the transaction's life, the most-current information and estimate of collateral value are easily accessible by inspection of the digital certificate through the secure portal 106. Other parties can also be provided with visibility into the digital certificate, as will be discussed in greater detail herein.

In one embodiment the blockchain blob is associated with a digital certificate by linking the blockchain blob to a certificate identifier that uniquely identifies the digital certificate.

An initial investor ‘closes’ the digital certificate by funding the costs associated with the purchase of the goods required to fulfill the purchase order. This initial funding of the digital certificate is recorded within a blockchain blob of the digital certificate along with the payment information associated with the wiring to the supplier for the goods, and can be considered as a ‘warehouse’ closing of the asset which is then eligible to be transferred to any other investor.

Ownership of a digital certificate should be more secure than a UCC filing against the goods, as the digital certificate contains ‘No Contest’ clauses that ensure that the SPTC 104, as owner of the goods and issuer of the digital certificate, is agent for the digital certificate owner in any asset recovery efforts. Further, the ownership of the intermediate goods (prior to their delivery to the ultimate buyer) is specifically recorded on the books of the SPTC 104 as being ‘for the benefit of’ the digital certificate holder.

In step 5, the SPTC 104 uses the proceeds from the issuance of the digital certificate to directly pay transaction expenses—for the goods provided by the supplier. Often, there will be more than one supplier of goods—as the assigned purchase order may include items from multiple suppliers. If there are multiple suppliers, a completely funded digital certificate will provide for all payments to all suppliers. Remuneration flows directly to a supplier without passing through any party accounts. This, together with the transaction documents executed by SME in the assignment of the purchase order ensure that actual title to the goods is held directly by the SPTC 104 direct ownership rights being better than derived ownership rights.

In step 6 the supplier, in accordance with the instructions associated with the assigned purchase order, delivers the goods as directed. The title to these goods is held in the name of the SPTC 104. However, there is often some executory obligation by the SME to add some value to the goods as part of the assigned purchase order. This value addition, by the SME, which is specified in the transaction documents held within the digital certificate, might be simple delivery of the goods, or may include an installation component, or perhaps even some assembly with other goods from suppliers included within the digital certificate. A digital certificate can comprise of all goods required to fulfill an assigned purchase order.

In step 7, once the goods are delivered to the buyer and acknowledgment is received from the Buyer that all is in compliance with the purchase order, then a final Invoice is delivered to the buyer, specifying the final amount due and directing the buyer to make payment to the account of the SPTC 104 as previously agreed.

In step 8, the buyer makes final payment to the specified account as agreed under the assignment and purchase order for the goods delivered. In step 9, the SPTC 104 receives the payment from the buyer and allocates the senior-most portion under the terms of the digital certificate. The subordinated, residual payment is reserved to pay the SME owner.

In some embodiments, the SPTC 104 makes the senior-most payment to the owner associated with the digital certificate, and the digital certificate is marked as “Paid. The digital certificates can expire once payment-in-full has been received. These ‘expired’ digital certificates cannot be traded further, but might be retained by their owners for historical analysis.

The concept of a digital certificate is specifically designed to not constitute debt. The SPTC 104 is not intended to be a lender to the entrepreneur or to any other party to a trade. Rather, the SPTC 104 is a participant in the transaction and it will directly take title to the goods and directly collect the proceeds received from the buyer. At no time does the SPTC 104 give funds to the SME owner that might need to be repaid by the SME. Instead, as a participant in the transaction, the SPTC 104 is more akin to a special ‘supplier’ to the SME than to any other relationship. As this special supplier, the SPTC 104 has adjusted the commercial terms under which the goods are to be paid for—allowing the end buyer to pay into an account that will be used to satisfy the amounts due and to ensure that the distribution of these collections proceeds as indicated in the agreements (with the digital certificate holder having the senior-most collection rights). The SPTC 104 seeks to remain as simply a commercial counterpart to and a monitor of the transaction; it does not seek the role of creditor, except in the commercial sense.

When the SME owner enters into an assignment agreement with respect to a digital certificate, the compensation for the financing that is to be provided is determined based upon multiple factors. In one embodiment, first, there is an origination fee, charged to the transaction at issuance of the digital certificate (e.g., 1.25-5% of the funds required). Second, there is a time-based calculation that covers the ‘trade margin’ or the ‘profit’ that the SPTC 104 collects for advancing funds, paying the supplier, etc. This time-based calculation of profit is calculated much like an interest rate would be calculated—but it is very clearly not interest—as the digital certificate process is specifically designed to not be debt (see above). Instead, trade margin accrues at the rate of X% per day that the financing is outstanding. A typical accrual of trade margin might be quoted at two percent per month (calculated using actual days elapsed with at 30 day month assumed). The accrual rate for trade margin is a fundamental transaction parameter that is agreed with the SME prior to processing the proposed digital certificate.

In some embodiments there is an allocation of risk based upon foreign exchange. Typically, the currency in which payment is to be made may not be the same currency in which the digital certificate is funded. If this is the case, then there is a future FX rate (a ‘Forward Rate’) established and agreed between the entrepreneur and the SPTC 104 of what can constitute settlement. For example, let's assume that the digital certificate is to be funded in USD and the final settlement or payment by the Buyer is in RWF—for Rwandan Franks. If, at the time of payment to the supplier the FX rate is 760 RWF/1 USD, but the expected FX rate, 90 days forward, when the Buyer is expected make final payment, is expected to be 980 RWF/1 USD, then a fixed-final settlement cost to the transaction is calculated as if the forward FX rate will, in fact, be 980 RWF/1 USD. This fixed, forward FX rate will apply if payment occurs within a ‘window’ of time that is plus or minus 3 days of the original expected settlement date. If the final settlement date moves outside of that pre-agreed window, then the FX rate will be set by the SPTC based on market rates.

In one embodiment, if payment is in a foreign currency and is to be made at a bank that may possibly charge out-of-market rates for FX an additional FX reserve may be charged to the transaction. (The actual FX rate available to some retail customers is often significantly different from the market quoted FX rate—this is called the retail bid-offer spread.) The RX reserve is usually time-based and is quoted and calculated in similar fashion to the trade-margin accrual (e.g., 1% per month, actual days, 360 day year).

In sum, the final, senior-most collection right that is collected out of settlement proceeds paid by the buyer of the goods, comprises 1) an origination fee, 2) a time-based calculation of trade margin, 3) a set FX rate that applies if the transaction settles in a pre-determined window of time, and 4) a reserve that accumulates to cover actual FX conversion risk.

As mentioned above, the digital certificate can be subject to certain ownership rights that are transferrable. In some embodiments, the digital transaction certificate system 102 creates a valid electronic ownership token that is provided to an owner of the digital certificate. This electronic ownership token entitles the owner to all rights and benefits attached to the digital certificate via the embedded agreements—including payment rights at the time of final settlement. The possessor of the ownership token presents the token any time on or after the initial maturity date of the digital certificate and in settlement receives all of the collections due and collected on that trade. The only requirement on the person or entity who presents the ownership token, is that they be cleared, via a KYC (know your customer) analysis executed by the digital transaction certificate system 102, to utilize the international banking system. In some embodiments, KYC-qualified token owners can receive payment on the digital certificate.

In one embodiment a digital ‘coin’ or token that represents a trade transaction could comprise ‘colored coins’ associated with Bitcoin transactions and other digital asset systems. In on embodiment the digital transaction certificate system 102 creates an encoding of all or a portion of the digital certificate using SHA256 encoding.

That token also provides complete (or selectively controllable) visibility into the contents of a digital certificate. The owner of a digital certificate can grant different levels of ‘visibility rights’ into a digital certificate, where non-confidential information about the digital certificate can be shared. This allows the owner to allow other potential buyers (or other parties) of the digital certificate to inspect it if it is offered for sale.

The digital transaction certificate system 102 provides online digital certificate viewers a way to obtain views into the digital certificate using the secure portal described above.

Some of the views are best for individual scrutiny of a single digital certificate and other views are best for portfolio-level views. An entire collection of digital certificates can be viewed in aggregate with various comparative and statistical measures, allowing the owner to monitor the progress of trades in their portfolio and to make decisions about selling or retaining the assets they own.

In some embodiments, there are two methods for accessing the information associated with a digital certificate, such as the blockchain blob. First, all information associated with a digital certificate is available via a publicly available API associated with the digital transaction certificate system 102. This API allows the possessor of an ownership token for a digital certificate to access up-to-the-minute information about that digital certificate, which can include any of: the initial information associated with the issuance decision, all records of the financial payments made on the account of the digital certificate (e.g., to suppliers or as bank fees, etc.), all documentation associated with the transaction, all communications with transactions counterparts, and all payments received with respect to payments by the Buyer. This API-based access is available through a cloud-based service facilitated by the digital transaction certificate system 102.

In some embodiments the digital transaction certificate system 102 regularly publishes an encrypted ‘blob’ of data in multiple public forums that contain the time-stamped entirety of data associated with a digital certificate as at that date. Again, this can be done in a blockchain format. This publicly distributed data will be encrypted so that the ‘ownership token’ provides access to all information within the blob. The public distribution of the time-stamped blob ensures that the information is accurate as at the time indicated.

Note that the blockchain aspects of this digital certificate data provide a mechanism whereby the information associated with an asset can be directly attached to that asset, and traded freely along with the other ownership rights. This configuration is superior to having ‘rights’ to access data but having the asset ownership ‘detached from’ access to the information itself. Since trade transactions are complex and might involve distant locations, the current information about a transaction is more easily transported than requiring the owner to make a due-diligence visit to a ‘servicer’ to access the transaction information.

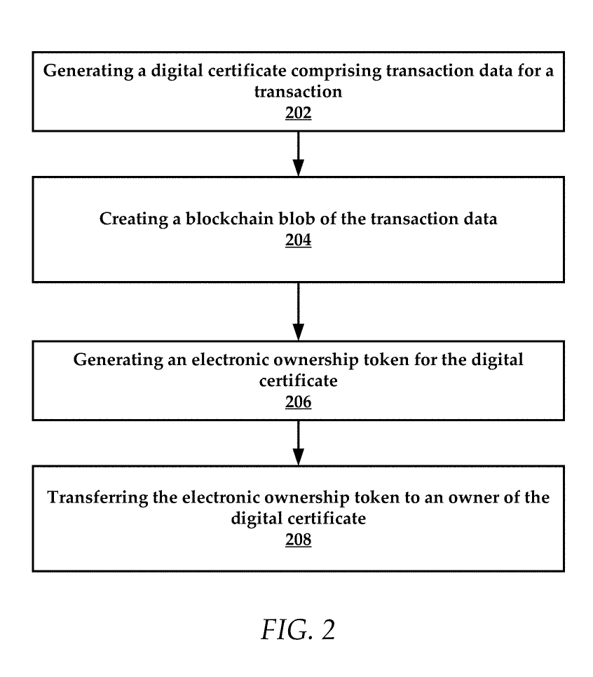

FIG. 2 is a flowchart of an example method of the present disclosure. In one embodiment, the method includes a step 202 of generating a digital certificate comprising transaction data for a transaction. For example, the digital certificate includes the basic information for a proposed transaction, as well as the behavioral analyses of parties, documents, and other ancillary information regarding the transaction.

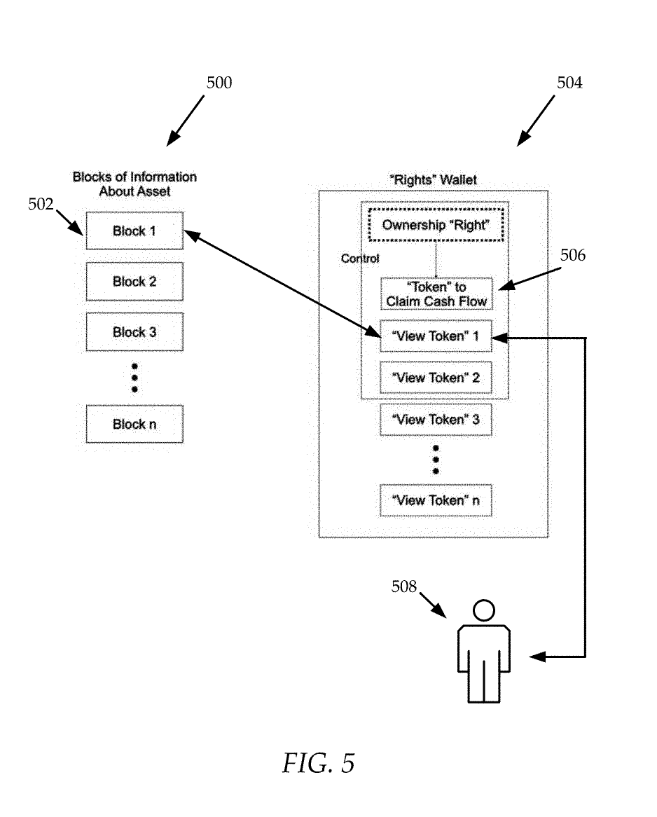

In some embodiments, the method includes a step 204 of creating a blockchain blob of the transaction data. An example blockchain blob creation process is illustrated in FIG. 5.

According to some embodiments, the method includes a step 206 of generating an electronic ownership token for the digital certificate. This process can occur after the digital certificate has issued in some embodiments. Thus, the digital certificate has been assigned an owner. A token can include an electronic indication of ownership that designates a current owner of the digital certificate.

Next, the method includes a step 208 of transferring the electronic ownership token to an owner of the digital certificate. As mentioned above, in one embodiment, the owner of the token and digital certificate can create various visibility rights for the digital certificate that allow additional parties to inspect contents of the digital certificate.

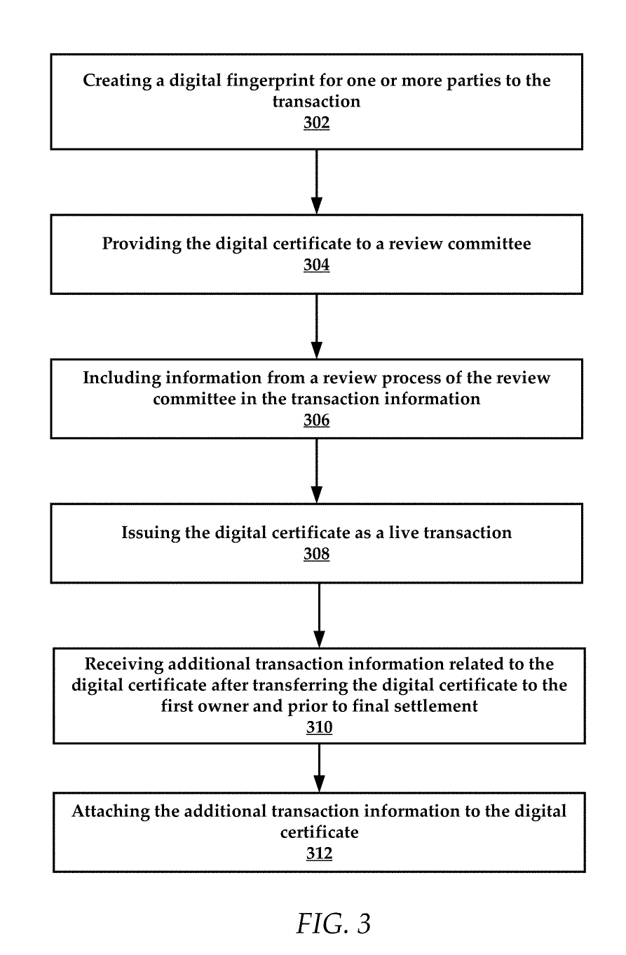

FIG. 3 is a flowchart of another method that includes aspects of creating digital information for the digital certificate. In one embodiment, the method includes a step 302 of creating a digital fingerprint for one or more parties to the transaction. The digital fingerprint is a score based on behavioral information and publically available data related to a party, as well as privately held or proprietary data sources (even including confidential data).

In some embodiments, the method includes a step 304 of providing the digital certificate to a review committee and a step 306 of including information from a review process of the review committee in the transaction information.

In one embodiment, the method includes a step 306 of digitally signing the digital certificate by the first party and the second party prior to issuing the digital certificate as a live transaction.

The method also includes a step 308 of issuing the digital certificate as a live transaction.

In accordance with the aspects of the evolving nature of the digital certificate, the method includes a step 310 of receiving additional transaction information related to the digital certificate after transferring the digital certificate to the first owner and prior to final settlement. Thus, any views of the digital certificate, ownership transfers, documents, and other related data are appended to the digital certificate. Thus, the method includes a step 312 of attaching the additional transaction information to the digital certificate.

In some embodiments, parties associated with the transaction upload documents relating to the transaction to the secure portal.

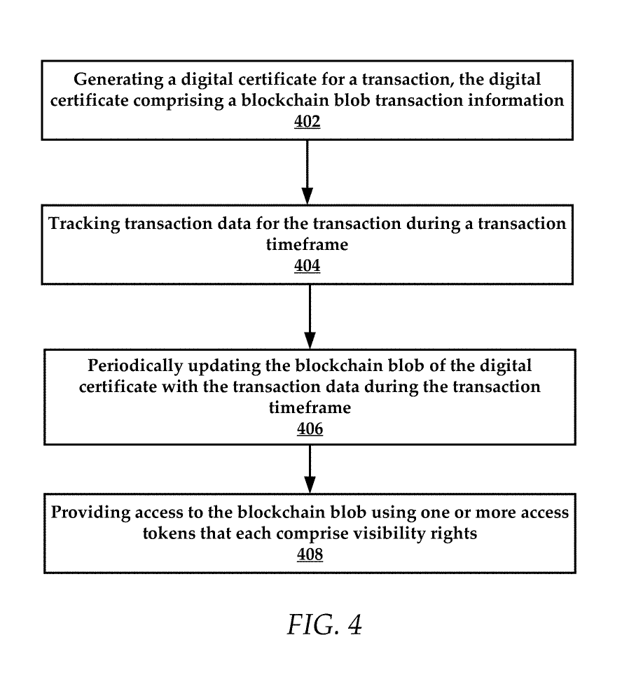

FIG. 4 is a flowchart of another example method that includes a step 402 of generating a digital certificate for a transaction. In some embodiments, the digital certificate comprises blockchain blob transaction information.

The method includes a step 404 of tracking transaction data for the transaction during a transaction timeframe. In some embodiments, the timeframe extends between the creation of a proposed transaction to final settlement of the transaction.

In some embodiments, the method includes a step 406 of periodically updating the blockchain blob of the digital certificate with the transaction data during the transaction timeframe. Next, the method includes a step 408 of providing access to the blockchain blob using one or more access tokens that each comprises a unique set of visibility rights. For example, a potential buyer can be granted visibility rights to a portion of the transaction information in the digital certificate, whereas an investor can be granted different visibility rights.

The present disclosure contemplates various secure measures that ensure that data is securely tracked and access to the data (or a portion of the data) is restricted using secure view tokens. For example, a patient electronic medical record (EMR) contains both sensitive information (PII or personally identifiable information that is subject to one or more federal law such as HIPPA) and non-sensitive information. The non-sensitive information can be assigned to view tokens. When a party that is not authorized to review the sensitive information in the EMR needs non-sensitive information from the EMR, the party is provided with a view token. The party presents the view token for access to the information linked to the view token.

FIG. 5 illustrates an example representation of a block chain blob 500 that comprises a plurality of blocks such as block 502. Each of the blocks comprises an instance of transaction data, for example, in an EMR. The information in Block 1 could comprise diagnostic information such as x-rays or prescription drugs. Block 2 could comprise sensitive information such as name, address, insurance information, or other sensitive information. The remaining blocks include other portions of the EMR.

The owner of the EMR, such as the patient, can be provided with a rights wallet 504 that is a control mechanism that includes both ownership rights that indicate who owns the EMR. In some instances the ownership rights might be vested with a third party (e.g., a party that is not the subject of content included in the block chain blob 500).

The rights wallet 504 comprises a plurality of view tokens, such as view token 506. The view token identifies a block(s) that is mapped to the view token. The view token can also include permissions or rights that dictate or control access rights to the content in the linked block. For example, the view token can specify that the holder of the view token can read or copy the content of a block but not edit or delete.

Multiple blocks can be mapped to a single view token and multiple tokens can be mapped to a single block in the block chain blob 500. The distribution of view tokens allows an owner of the block chain blob 500 to distribute access to only portions of the block chain blob 500, while the remainder of the block chain blob 500 is inaccessible. The owner need not worry about unauthorized access to portions of the block chain blob 500 that have not specifically been assigned to a view token and provided to a party.

In one embodiment block 502 is assigned to view token 506 and the view token is transmitted to a first party 508. The first party 508 provides the view token back to the system when the first party 508 desires to access the data in block 502.

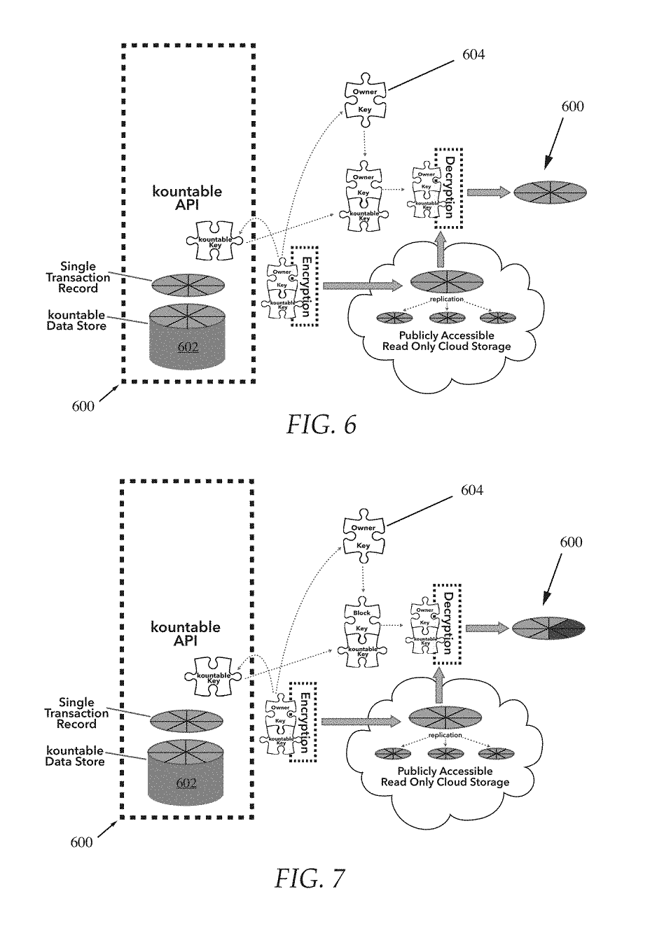

FIGS. 6 and 7 collectively illustrate the process of creating a block chain blob 600 that is stored in a data store 602. Individual transaction records are stored in the block chain blob 600. An API is used to encrypt the data from the block chain blob 600 prior to delivery of the data when a view token is received. The view token is illustrated as a puzzle piece 604. In FIG. 6 the data requested with a view token is decrypted, such as the entire block chain blob 600. In FIG. 7, only a portion of the block chain blob 600 is decrypted.

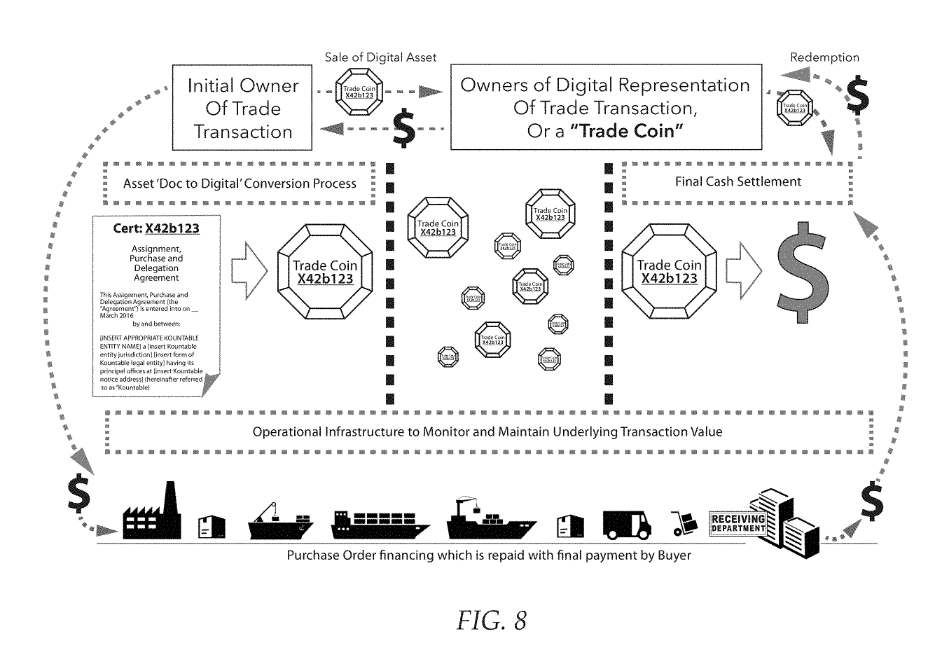

FIG. 8 illustrates another use case for implementation of the systems and methods of the present disclosure. The system in FIG. 8 originates a “Trade Transaction” opportunity for which it will maintain the operational responsibility to monitor and maintain the underlying Trade Transaction in the role of “Project Manager.”

The Trade Transaction is underwritten and an “Initial Owner” is identified that wishes to initially fund the Trade Transaction.

The Trade Transaction is documented as a “Trade Certificate” via an Assignment, Purchase and Delegation Agreement which is then funded with Cash by the Initial Owner.

The Initial Owner of Trade Transaction ‘converts’ the previously funded Trade Certificate (which is based upon the Assignment, Purchase and Delegation Agreement) into a digital representation (e.g., block chain blob) of the Trade Transaction which is called a “Trade Coin.”

The digital Trade Coin is sold by the Initial Owner into a blockchain market where it is freely traded.

When Cash has been received with respect to the underlying Trade Transaction the Owner(s) of the digital Trade Coin(s) redeem the Trade Coins for the available Cash.

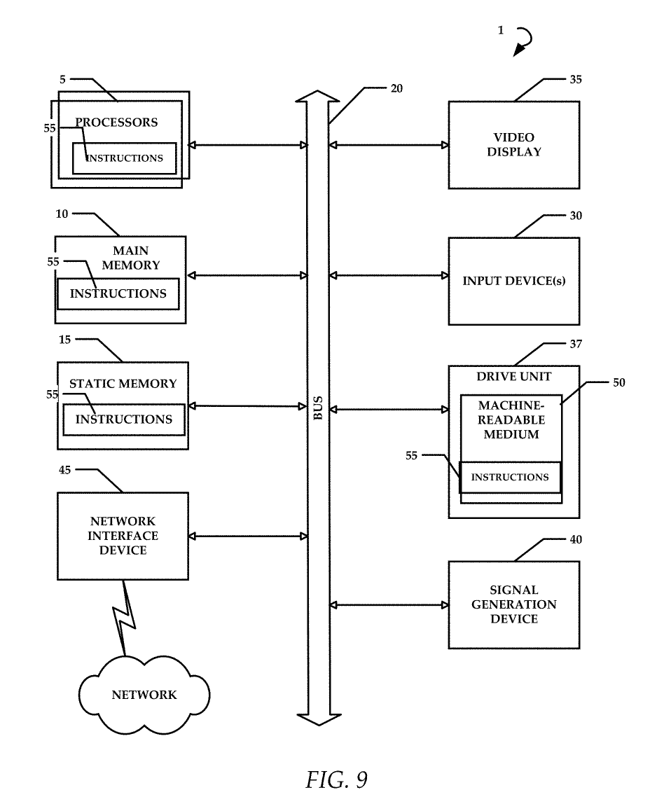

FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure. For example, the technology is not limited to use for stopping email threats, but applies to any messaging threats including email, social media, instant messaging, and chat.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
generating a digital certificate for a transaction, the digital certificate comprising a blockchain blob of transaction information;
generating a unique certificate identifier for the digital certificate;
linking the blockchain blob to the unique certificate identifier;
tracking transaction data for the transaction during a transaction timeframe;
periodically updating the blockchain blob of the digital certificate with the transaction data during the transaction timeframe using the unique certificate identifier; and
encoding at least a portion of the blockchain blob to create one or more access tokens, wherein the one or more access tokens comprise visibility and access rights;

2. The method according to claim 1, further comprising distributing the one or more access tokens to recipients.

3. The method according to claim 2, further comprising:
receiving a request to receive the at least a portion of the blockchain blob from one or more of the recipients, the request comprising at least one of the one or more tokens;
authenticating the at least one of the one or more tokens; and
providing access to the blockchain blob in accordance with the visibility and access rights associated with the at least one of the one or more tokens.

4. The method according to claim 1, wherein the transaction data comprises any of ownership transfers of the digital certificate, supporting documentation for the transaction, behavior data for any party to the transaction, behavior scores for any party to the transaction based on the behavior data, publically available information and privately-held financial and personal information, and any combinations thereof, and wherein each instance of transaction data is time-stamped.

5. The method according to claim 1, further comprising obtaining location data of devices utilized in the transaction and associating the location data with instances of transaction data created using the devices.

6. The method according to claim 1, wherein the transaction timeframe extends from a transaction initiation and a final settlement of the transaction.

7. The method according to claim 1, further comprising:
encrypting the blockchain blob; and
publishing the encrypted blockchain blob to one or more public forums.

8. The method according to claim 1, further comprising generating a digital fingerprint for a first party associated with the transaction.

9. The method according to claim 8, wherein the digital fingerprint is a score based on behavioral information, publically available data, privately held data, or combinations thereof related to the first party.

10. The method according to claim 9, wherein the transaction data comprises any one of a definition of goods, information regarding a second party, a supplier of the goods, shipping information for the goods, transaction amounts, time frames for portions of the transaction, and combinations thereof.

11. The method according to claim 1, further comprising:
providing the digital certificate to a review committee; and
including information from a review process of the review committee in the transaction information.

12. The method according to claim 1, further comprising issuing the digital certificate as a live transaction.

13. The method according to claim 12, further comprising digitally signing the digital certificate by a first party and a second party prior to issuing the digital certificate as a live transaction.

14. The method according to claim 12, further comprising:
funding the digital certificate; and
transferring the digital certificate to a first owner.

15. The method according to claim 14, further comprising:
receiving additional transaction information related to the digital certificate after transferring the digital certificate to the first owner and prior to final settlement; and
attaching the additional transaction information to the digital certificate;
wherein parties associated with the transaction will upload documents relating to the transaction to a secure portal, the documents relating to the transaction being a part of the additional transaction information.

16. The method according to claim 15, wherein the owner designates visibility rights in the digital certificate to another party, which include non-confidential portions of the transaction information.

17. A method for generating and using a digital rights wallet, comprising:
generating a plurality of view tokens that each are linked to at least one blob of a blockchain blob, the blockchain blob comprising transaction information, wherein the plurality of view tokens comprise permissions or rights that dictate or control access rights to content content in the at least one blob;
distributing one or more of the plurality of view tokens to one or more recipients;
receiving at least one of the one or more of the plurality of view tokens; and
providing access to only those portions of the blockchain blob corresponding to the at least one of the one or more of the plurality of view tokens that were received.
